(19) United States
(12) Patent Application Publication
(10) Pub. No.: US 2004/0177317 A1
(43) Pub. Date: Sep. 9, 2004

(54) Closed caption navigation

(76) Inventor: John Bradstreet, Sammamish, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/384,087

(22) Filed: Mar. 7, 2003

(51) Int. Cl. G06F 17/21

(52) U.S. Cl. 715/500.1

(57) ABSTRACT

A transcription file enables navigation through multimedia content and dictates the manner in which the multimedia content is rendered. The transcription file is derived from multimedia content received by a computing system that is scanned for closed caption strings and other content that is used for creating tokens that are linked to one or more corresponding multimedia elements. The transcription file and tokens can be displayed as a combination of images and text by a user interface. The selection of a displayed token from the interface initiates the rendering of the multimedia content, commencing with the rendering of the one or more multimedia elements that are linked to the selected token. The interface is also configured for word processing and editing the transcription file, for enabling a user to modify the manner in which the multimedia content is rendered.

### BACKGROUND OF THE INVENTION

1. The Field of the Invention

The present invention generally relates to the methods and systems for processing multimedia content and, more particularly, to methods and systems for navigating through multimedia content, including broadcast multimedia.

2. Background and Relevant Art

Many rendering devices and systems are currently configured to render multimedia content, such as video, music, text, images, and other audio and visual content, in a user-friendly and convenient manner. For example, some Video Cassette Recorders (VCRs), Programmable Video Recorders (PVRs), Compact Disk (CD) devices, Digital Video Disk (DVD) devices, and other rendering devices are configured to enable a user to fast-forward, rewind, or skip to desired locations within a program to render the desired multimedia content and in a desired manner.

The convenience provided by existing rendering devices and systems for navigating through multimedia content, however, is somewhat limited by the format and configuration of the multimedia content. For example, if a user desires to advance to a particular point in a recorded program on a videocassette, the user typically has to first fast-forward or rewind through certain amounts of undesired content before advancing to the desired content. Even when the recorded content is stored in a digital format, the user may still have to incrementally advance through some undesired content before the desired content can be rendered. The amount of undesired content that must be advanced through is typically less, however, because the user may be able to skip over large portions of the data with the push of a button.

Some existing DVD and CD systems also enable a manufacturer to define and index the multimedia content into chapters, scenes, clips, songs, images and other predefined audio/video segments so that a user can select a desired segment from the menu to begin rendering the desired segment. Although a menu can be convenient, existing navigation menus are somewhat limited because the granularity of the menu is constrained by the manufacturer rather than the viewer, and may, therefore, be somewhat coarse. Accordingly, if the viewer desires to begin watching a program in the middle of an chapter, the viewer still has to fast-forward or rewind through undesired portions of the chapter, prior to arriving at the desired starting point, even when the appropriate chapter has been selected from the menu.

Yet another problem with certain multimedia navigation menus is that they do not provide enough information for a viewer to make an informed decision about where they would like to navigate. For example, if the navigation menu comprises an indexed listing of chapters, the viewer may not have enough knowledge about what is contained within each of the recited chapters to know which chapter to select. This is largely due to the limited quantity of information that is provided by existing navigation menus.

Yet another known problem with navigating through multimedia content is experienced when the multimedia content is recorded from a broadcast (e.g., television, satellite, Internet, etc.) because broadcast programs do not include menus for navigating through the broadcast content. For example, if a viewer records a broadcast television program, the recorded program does not include a menu that enables the viewer to navigate through the program.

Some PVRs enable a user to skipping over predetermined durations of a recorded broadcast program. For example, a viewer might be able to advance 30 minutes or another duration into the program. This, however, this is blind navigation at best. Without another reference, simply advancing a predetermined duration into a program does not enable a user to knowingly navigate to a desired starting point in the program, unless the viewer knows exactly how far into the program the desired content exists.

### BRIEF SUMMARY OF THE INVENTION

The present invention generally relates to methods and systems for navigating through multimedia content, including, but not limited to broadcast multimedia.

According to one aspect of the invention, a computing system includes modules for receiving and processing multimedia content and for creating and editing transcription files that can be used to navigate through the multimedia content. According to one embodiment, the transcription file includes tokens that correspond directly to the multimedia content by timestamp and dictate the sequence in which the corresponding multimedia content is rendered.

When multimedia content is received by the computing system, the multimedia content is scanned for closed caption and subtitle strings and other transmitted or derived data that can be used as a basis for creating tokens that are linked to the corresponding multimedia content. The tokens of the transcription file may correspond to various multimedia elements of varying granularity and type. For example, a token may correspond to textual multimedia elements (e.g., a chapter, sentence, word, letter, and so forth), audio multimedia elements (audible speeches, sentences, phrases, words, and sounds, musical scores, meters, bars, notes, and so forth), video multimedia elements (e.g., scenes, clips, images, and so forth), combinations of the above, as well as any other multimedia elements. Types of tokens are limited only by the ability to extract them from the data.

According to one embodiment, the granularity (e.g., size) of the multimedia elements assigned to the navigation tokens that are displayed by the transcription file can be controlled by the user. By way of one example, a user can control whether the displayed tokens correspond to a chapter, sentence, word, a letter or other multimedia element of any definable size.

According to another aspect of the invention, the transcription file and corresponding tokens are displayed by a user interface that is configured to display images and text. The tokens can be displayed as any combination of images and text by the user interface. The selection of a displayed token from the transcription file initiates the rendering of the multimedia content, which may include any combination of audio or visual content, commencing with the rendering of the one or more multimedia elements that are linked to the selected token of the transcription file.

In certain embodiments, the interface displaying the transcription is also configured for performing word processing and editing, such that the transcription file and corresponding tokens can be edited with the user interface. Accordingly, a user can modify the manner in which the multimedia content is to be rendered by editing the transcription file.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of one embodiment of a computing environment in which methods of the invention may be practiced;

FIG. 2 illustrates one embodiment of a flowchart of a method for enabling navigation through multimedia content according to one embodiment of the present invention;

FIG. 3A illustrates one embodiment of a transcription file and corresponding tokens displayed by an interface;

FIG. 3B illustrates one embodiment of a transcription file displayed concurrently with the multimedia content that corresponds to the transcription file; and

FIG. 4 illustrates a block diagram of one embodiment of a computing environment in which methods of the invention may be practiced.

### DETAILED DESCRIPTION OF THE PREFERRED EMBODIMENTS

The present invention extends to both methods and systems for navigating through multimedia content, including, but not limited to broadcast multimedia.

According to one aspect of the invention, multimedia content received by a computing system is scanned for closed caption strings, subtitles, and other data that can be used as a basis for creating a transcription file that includes navigation tokens linked to the multimedia content by timestamp and that can be used to navigate through the multimedia content. According to one embodiment, the transcription file dictates the manner in which the corresponding multimedia content is rendered, such that the transcription file can be edited to alter the intended presentation of the multimedia content. Additional features and advantages of the invention will be set forth in the description which follows.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be Hz any available media that can be accessed by a general purpose or special purpose computer. By way of example, and not limitation, such computer-readable media can comprise RAM, ROM, EEPROM, CD-ROM, DVD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

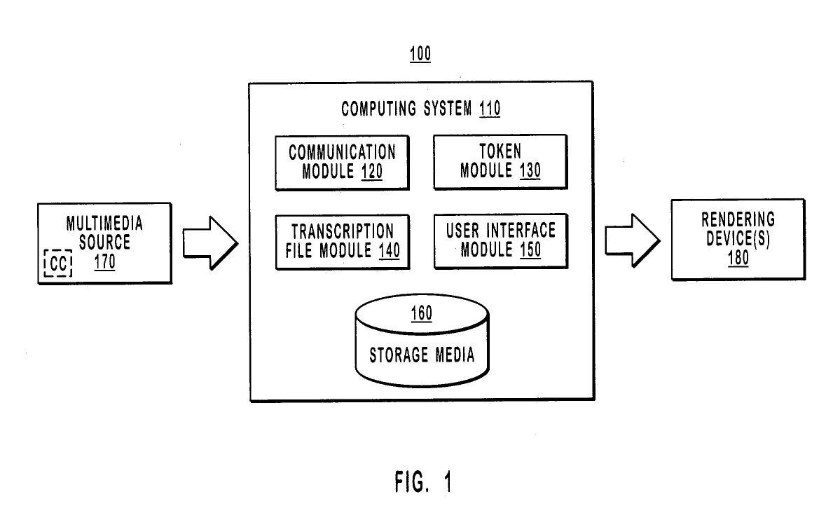

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

FIG. 1 illustrates one embodiment of a computing environment 100 in which methods of the invention may be practiced. The computing environment 100 includes a computing system 110 that is configured to process multimedia content with various computing modules, including a communication module 120, a token module 130, a transcription file module 140 and a user interface module 150, each of which will now be described.

The communication module 120 generally includes computer-executable instructions for enabling communication between the computing modules 130, 140 and 150. The communication module 120 also enables communication between the computing system 110 and the multimedia source 170 and the rendering device(s) 180. The communication module 120 is configured with computer-executable instructions for identifying closed caption text, metadata, sideband data, and other data included with the multimedia content and that is provided to characterize or define the multimedia content. Accordingly, the communication module 120 may also include computer-executable instructions for performing voice recognition, optical character recognition, or other recognition techniques to identify the data corresponding to the multimedia content that can be used as a basis for forming navigation tokens to navigate through the multimedia content, as described below.

The token module 130 generally includes computer-executable instructions for creating tokens that relate to elements of the multimedia content. The tokens that are created by the token module 130 can include visual images (e.g., text, pictures, animations, and so forth) and timestamps that correspond to elements of the multimedia content. Each navigation token comprises a link to the one or more multimedia elements to which it corresponds so that when a token is selected, the corresponding multimedia elements can be accessed and rendered.

As described herein, multimedia elements can include any combination of audio and visual content. Non-limiting examples of audio and visual elements that can be identified or referenced by navigation tokens include textual elements (e.g., a chapter, sentence, word, letter, and so forth), audio elements (e.g., audible speeches, sentences, phrases, words, and sounds, musical scores, meters, bars, notes, and so forth), video elements (e.g., scenes, clips, images, and so forth), and combinations thereof.

It will be appreciated that the tokens can correspond to any number, size and type of multimedia elements. For example, a first token may link to an element of multimedia content comprising a video segment having a 1 second duration. Another token may link to an element of multimedia content comprising a video segment of a 1 minute duration. Likewise, a token may link to a single word or a plurality of words. A token may also link to a single image or a group of images. It will be appreciated, however, that the foregoing examples are merely illustrative and not intended to limit the scope of the invention. Rather, the foregoing examples are provided to illustrate that tokens may be created to link to multimedia elements of varying size and type.

As mentioned above, each token also includes a timestamp corresponding with the timestamp of the one or more multimedia elements identified by the token. This enables the transcription file to reflect and in some cases dictate the manner in which the multimedia content is rendered, as described below.

According to one embodiment, the token module 130 also includes computer-executable instructions for accessing tables and other data structures in the storage media 160 that contain the transcription file, tokens, and additional sources for information that can be linked to the tokens. For example, the identification of a web page reference can be linked to a token by the token module 130, such that a selection of the token launches the URL corresponding to the token.

The transcription file module 140 includes computer-executable instructions for establishing the links between the tokens and the corresponding multimedia elements with appropriate pointers to the multimedia content so that a selection of a token can initiate rendering of the multimedia content. According to one embodiment, the links between the tokens and the multimedia elements are based on timestamp and recorded within a transcription file that can be stored within the local storage media 160 of the computing system 110 or a remote storage media in communication with the computing system 110. The transcription file can include, for example, a table, array or other data structure that identifies the tokens and any combination of corresponding timestamps, filenames, and other data needed to launch the one or more multimedia elements corresponding to the indexed tokens. The transcription file can also include references to URLs or other sources for obtaining related data.

The transcription file module 140 also includes computer-executable instructions for determining a hierarchal organization of the tokens within the transcription file. This can be useful, for example, to enable a user to control the granularity with which the transcription file enables navigation. A hierarchal organization can be configured, for example, to identify a group of multimedia elements that are linked individually to a plurality of different tokens on a first granularity level and that are linked collectively to a single token on a second granularity level. For example, each word in a sentence can be associated with a separate word token, while at the same time being associated with a sentence token. This example, however, is merely illustrative and should not therefore be construed as limiting the scope of the invention. The relationship between tokens and sub-tokens can also be stored in tables or other data structures within the storage media 160.

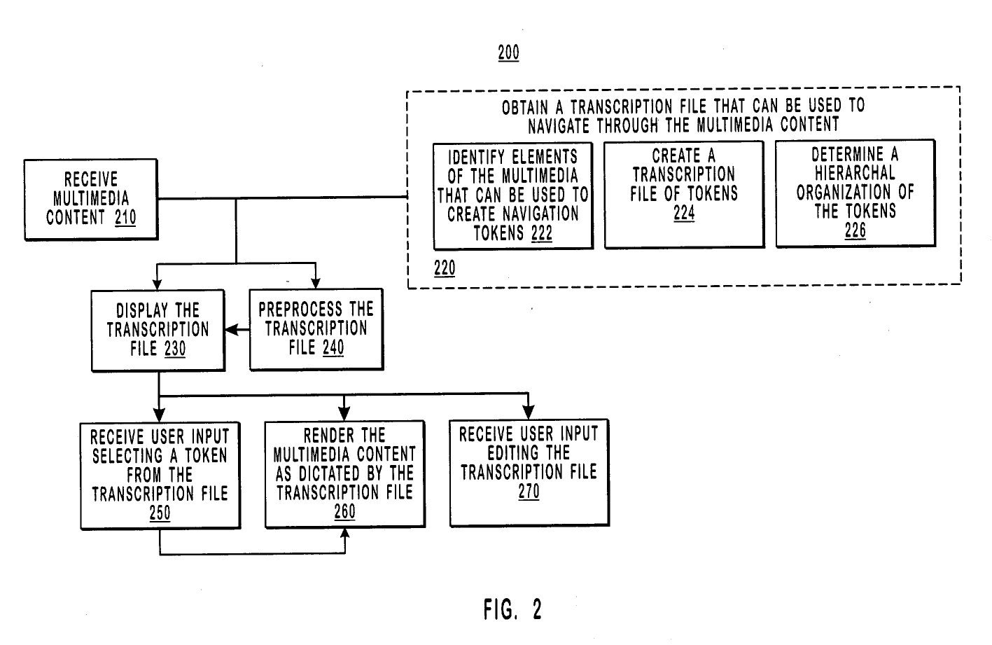

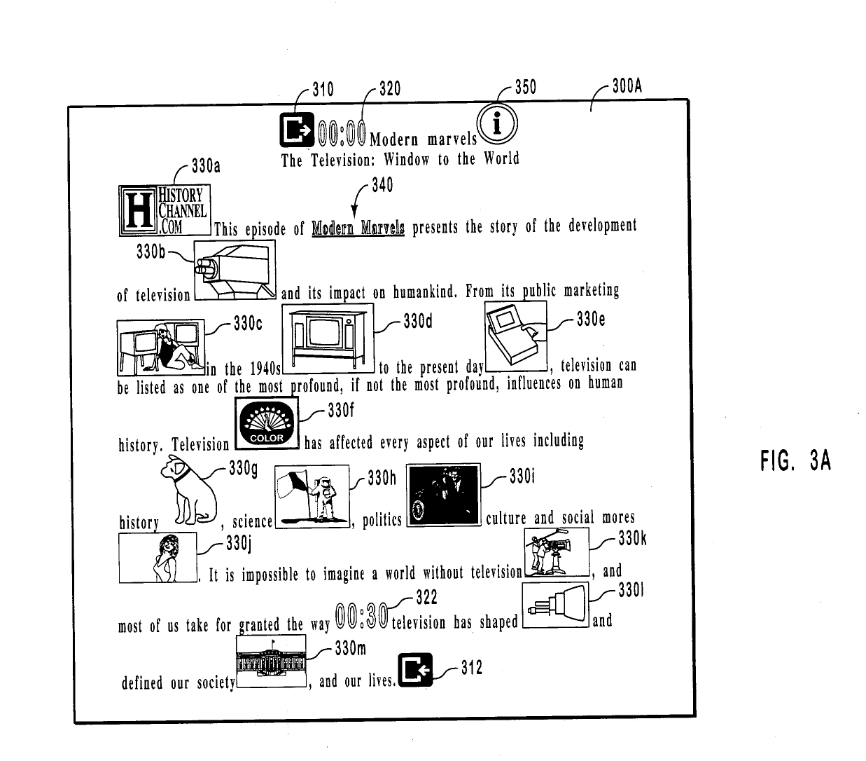

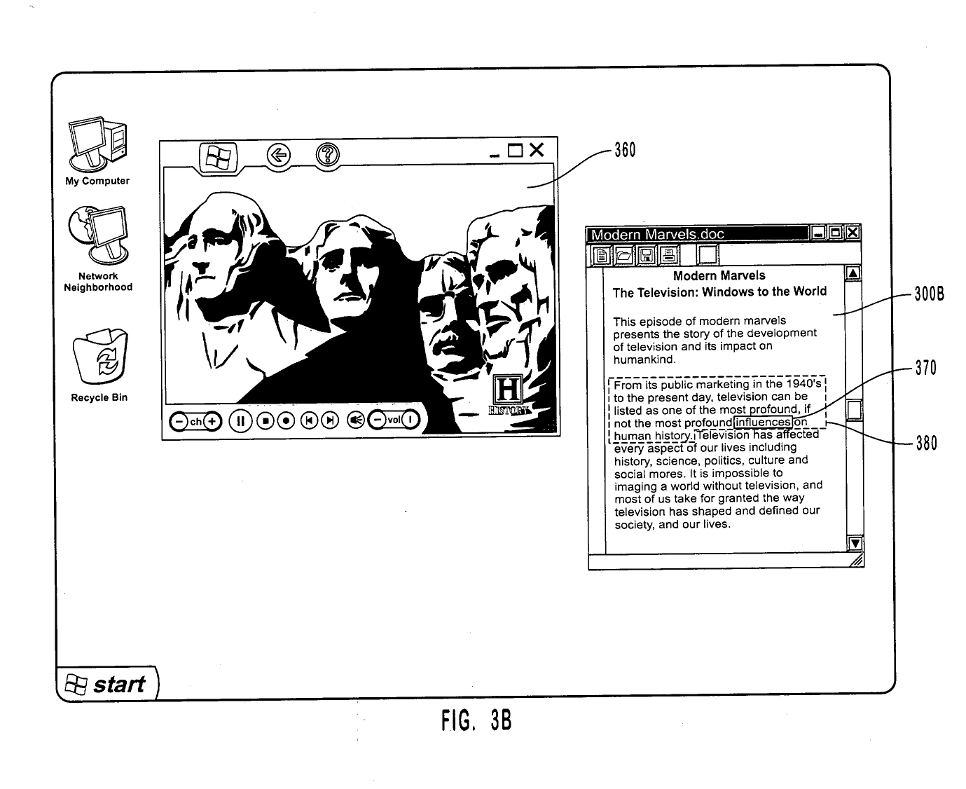

The user interface module 150 includes computer-executable instructions for providing a user interface that can display the transcription files of the computing system 110 at a monitor, television, or other display device, as described below with specific reference to FIG. 3. The interface module 150 can also include sufficient computer-executable instructions for editing the transcription files of the computing system 110. For example, the user-interface may enable portions of a transcription file (e.g., tokens) to be cut, pasted, moved, deleted, amended, spell-checked, or otherwise edited. Editing the transcription file can be performed, for example, to alter the appearance of the transcription file and corresponding tokens (e.g., changing font, token appearance, etc.). Editing the transcription file can also control the manner in which the corresponding multimedia is rendered, as described below in reference to FIGS. 2, 3A and 3B.

Attention is now directed to FIG. 2, which illustrates a flowchart 200 of one embodiment of a method of the invention for enabling navigation of multimedia content. As shown, the illustrated method includes various acts (acts 210, 222, 224, 226, 230, 240, 250, 260 and 270) and a step (step 220) for enabling navigation through multimedia content, each of which will now be described.

The first illustrated act (act 210) includes receiving multimedia content. According to one embodiment, multimedia content is received from a multimedia source 170, as illustrated in FIG. 1. The multimedia source 170 can include a broadcast station (e.g., television, satellite, etc.), a server or computing device, a storage media (e.g., magnetic diskette, compact disk, digital video disk, optical disk, and so forth), or any other medium configured to transmit multimedia content to the computing system 110. It will be appreciated that the act of receiving multimedia content (act 210) can also occur over a physical or wireless connection.

The multimedia content that is received from the multimedia source 170 can include any combination of audio and video data as well as metadata, sideband data or other data corresponding to the audio and video data. For example, the multimedia source 170 may be configured to transmit audio/visual data that includes cc (closed caption) data and metadata describing or corresponding with the audio/visual data. The closed caption data and metadata can then be identified by the computing system, as described above, and used as a basis for creating navigation tokens and a transcription file for navigating through the multimedia content.

Upon obtaining the multimedia content (act 210), the method includes the step for obtaining a transcription file that can be used to navigate through the multimedia content (step 220). The step for obtaining the transcription file can include any corresponding acts that are suitable for obtaining the transcription file. According to one embodiment, the step for obtaining the transcription file (step 220) includes the corresponding acts of identifying elements of the multimedia content that can be used to create navigation tokens (act 222), creating a transcription file of the tokens (act 224), and determining a hierarchal organization for arranging the tokens within the transcription file (act 226).

The act of identifying the elements of the multimedia content that can be used to create navigation tokens (act 222) may include identifying closed caption text, metadata, sideband data, images, sounds and any other data related to the multimedia content. Any suitable technique can be used to recognize and identify the content or data from which the navigation tokens are derived (e.g., voice recognition, optical character recognition, image recognition, word recognition, and so forth). For example, in one embodiment, identifying elements of the multimedia content to create navigation tokens (act 222) includes performing voice recognition to identify words, letters, and other sounds contained within the multimedia content. Act 222 may also include identifying scene changes, and other changes in the video data, as well as changes in the audio data of the multimedia content.

According to another embodiment, the act of identifying elements of the multimedia content that can be used to create navigation tokens includes identifying elements that are transmitted with the multimedia content, such as those elements that are obtained from additional media streams that are broadcast with the multimedia content. For example, streams providing news, sports, financial, weather, and other reports can be scanned with any suitable content recognition software including but not limited to audio, visual, textual, and voice recognition software.

The act of creating a transcription file of the tokens (act 224) includes creating tokens with timestamps that corresponding to the timestamps of the multimedia elements identified by the tokens. Creating the transcription file (act 224) also includes assigning images, text, animations or other visual representations to the tokens that can be displayed for selection by a viewer. The tokens are then linked to the one or more corresponding multimedia elements with pointers or other linking data structures.

According to one embodiment, the transcription file is generated at the computing system, as described above, in another embodiment, the transcription file is generated remotely from the client computer, such as, for example, by the broadcaster, program developer, a third party, etc. The transcription file can then by synced together with the content of the program at the client computer, by a third party, or in transit to the client computer.

The act of determining a hierarchal organization of the tokens (act 226) includes creating different levels of tokens that identify one or more sub-tokens and corresponding multimedia elements. The act of determining a hierarchal organization of tokens (act 226) generally involves determining the range in granularity that may be utilized to navigate through the multimedia content, as described herein. In particular, it is determined what amount of multimedia content is assigned to any particular token. By way of example, a first token may correspond to a first element, a second token may correspond to a second element that is different than the first element, and a third token may correspond to both the first and second elements. In this situation, the first and second elements may be referred to as sub-tokens. This concept if further described below in reference to FIG. 3B.

The method illustrated in FIG. 2 also includes an act of displaying the transcription file (act 230). This may include displaying the transcription file with a user interface simultaneously or independently of the multimedia content. For example, the transcription file may be displayed in a window proximate a window that is rendering the video of the multimedia content, thereby enabling a viewer to see the transcription file at the same time the viewer sees the multimedia content being rendered. The transcription file may also be displayed at a separate device that is used to render the multimedia content or at a separate time than the multimedia content is rendered.

The act of displaying the transcription file (230) includes displaying the visual representations of the tokens that are linked to the corresponding multimedia content. The interface that is used to display the transcription file may also include tools (e.g., scroll bars, menu options, etc.) for adjusting the granularity of the displayed tokens that are available for selection (e.g., determining whether paragraph, sentence, or word tokens are available for independent selection, as described below).

The method illustrated in FIG. 2 may also include an act of preprocessing the transcription file (act 240). Preprocessing may include such things as spell checking or formatting the transcription file for a desired presentation.

Once the transcription file is displayed, a user can select tokens from the transcription file (act 250) to initiate the rendering of the corresponding multimedia content. This will now be described with reference to FIGS. 3A and 3B.

FIG. 3A illustrates one embodiment of a transcription file 300A that is displayed by an interface. As shown, the transcription file includes several tokens that can be selected by a viewer. These tokens may include program tokens (310 and 312) that identify the beginning of a program, time marker tokens (320, 322) that identify time durations of the program, image tokens (330a-330m) that correspond to images from the program, textual tokens (340) that identify words spoken or displayed within the program, metadata tokens (350) that link to metadata about the program, or any other tokens that can identify and link to one or more multimedia elements.

When a token is selected, the computing system 110 initiates rendering of the corresponding multimedia content (act 260) commencing with rendering of the one or more multimedia elements corresponding to the selected token. For example, if the token 330b were selected, then the program would begin rendering the multimedia, starting with the content or multimedia elements corresponding to the 330b token. Likewise, if the token 322 were selected, the program would start rendering the program at the duration point 30 seconds into the program.

FIG. 3B illustrates one embodiment of a transcription file 300B that is displayed concurrently with the multimedia content that is being rendered on a separate window 360. In this embodiment, the transcription file 300B includes the closed caption text generated by the authors of the broadcast multimedia content. The closed caption text may, for example, be transmitted over a side band and reconstructed by the computing system and turned into tokens, as described above, such that each word in the displayed transcription file 300B can comprise a token that links to the corresponding multimedia element (word) in the program. Accordingly, when a word or token, comprising the word “influences” (token 370) is selected, then the program begins playing at the point in the program where the word influences is recited. Accordingly, the sequence and order in which the multimedia content is played back is controlled by the transcription file. During playback, an indicator of any type can be provided to reflect the actual playback position of the multimedia content as it is being played back.

As mentioned above, the interface used to display the transcription file may also include tools for adjusting the granularity of the tokens displayed for selection. Although specific tools (e.g., scroll bar, controls, menu options, etc.) are not illustrated, an example will now be provided to illustrate how adjusting the granularity of the tokens can provide enhanced control over navigation through the multimedia content. For example, with reference to FIG. 3, if the granularity is adjusted to a coarser granularity level, then the tokens that are available for independent selection might include whole sentences, rather than words. Token 380, for example, comprises a sentence token that includes numerous word tokens, including token 370. Accordingly, selection of any word contained within token 380, while in the coarser granularity mode, would initiate rendering of the multimedia program commencing with the first part of the sentence corresponding to token 380. Likewise, when in the finer granularity mode, selection of a word token such as token 370 would initiate rendering of the multimedia program commencing with the beginning of that word.

It will be appreciated that the ability to change granularity is not limited to textual tokens, but also extends to other tokens including, but not limited to, time tokens (e.g., token 320 and 322), image tokens (e.g., tokens 330a-330m), and program tokens (e.g., tokens 310 and 312). For example, the granularity of the program tokens 310 and 312 may be adjusted to reflect chapter tokens or scene tokens that can be independently selected.

When a token is selected, the corresponding multimedia content is identified with the token links and rendered on one or more suitable rendering device(s) 180. The rendering device(s) 180 can include monitors, speakers, and any other audio/visual equipment and systems that are configured to render audio and/or video content. According to one embodiment, only the multimedia content corresponding to a selected token is rendered. According to another embodiment, all multimedia content including and following a selected token is rendered unless it is stopped or interrupted, such as, for example, by the selection of another token.

FIG. 2 also illustrates that the methods of the invention can include receiving user input for editing the transcription file (act 270). The transcription file generally reflects the intended presentation of the multimedia content. Accordingly, a user can edit the transcription to modify the intended presentation of the multimedia content. For example, a user can copy, delete, move, or otherwise edit the transcription file to alter the manner/sequence in which the multimedia content is rendered. For example, the user may also wish to move scenes or paragraphs of the transcription file into a different order, such that when the multimedia content is rendered it will be rendered in a different order. Editing the transcription file may also be done for aesthetic reasons. For example, a user may wish to replace the image of a token with a replacement image to enhance the look and feel of the transcription file. The user may also wish to correct the spelling of a word.

A transcription file can also be edited by adding new content, such as portions of another transcription file, such that a user can create a new multimedia presentation from one or more existing multimedia presentations.

Editing the transcription file can also be performed to link a token to other information, such as a web page or other data files. For example, with reference to FIG. 3A, the metadata token 350A can be linked to a metadata file to provide additional information about the transcription file or the corresponding multimedia content. By way of another example, the token 330a might link to a web page containing additional information about the History Channel.

According to another embodiment, editing of the transcription file can occur externally from the client computer. In particular, editing may be accomplished by a broadcaster, censor group, or another third party, and then the edited transcription file can be transmitted to the client computer. It will be appreciated that the edits made to the transcription file can alter the playback experience for various users. In this manner, a user or a third party can effectively control what content is played and how it is played.

In summary, the present invention generally enables a user to navigate through multimedia content in a user-friendly manner. One benefit of the present invention is that it enables navigation through broadcast multimedia that does not already include navigation indexes. Another benefit is that the transcription file can be edited and adjusted to control how the corresponding multimedia content is rendered. It will be appreciated, however, that the present invention is not limited to embodiments in which the multimedia content comprises broadcast data or to embodiments in which the multimedia content does not include menus for navigation.

Computing Environment

Those skilled in the art will also appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

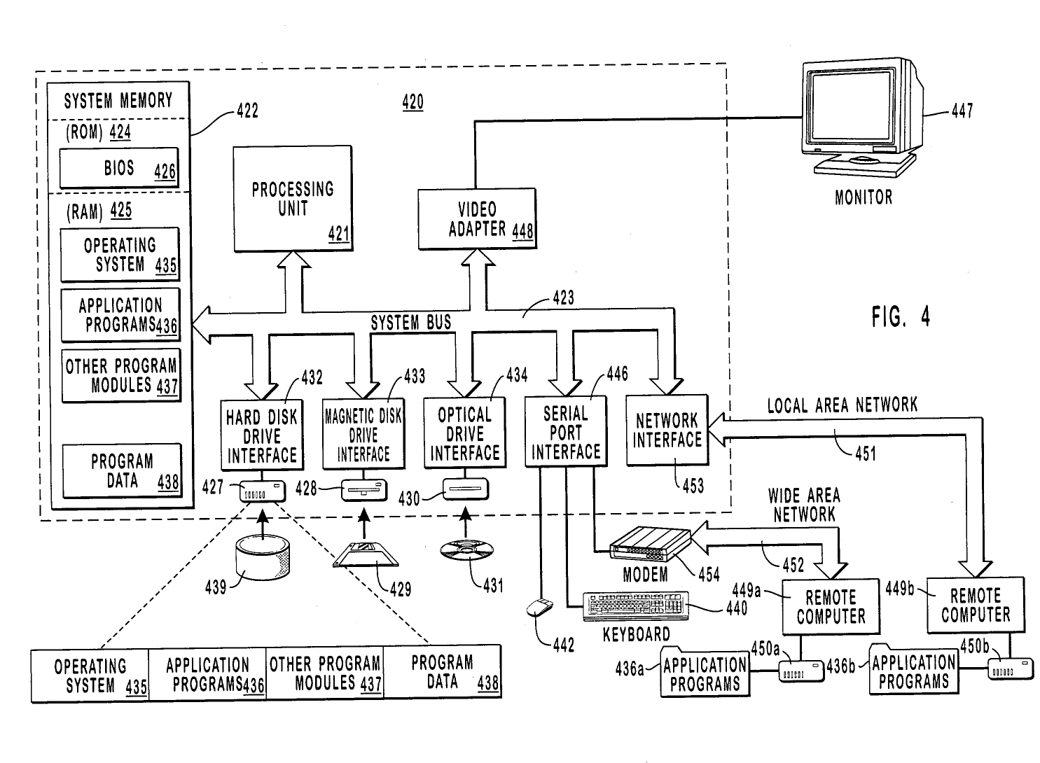

With reference to FIG. 4, an exemplary system for implementing the invention includes a general purpose computing device in the form of a conventional computer 420, including a processing unit 421, a system memory 422, and a system bus 423 that couples various system components including the system memory 422 to the processing unit 421. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disk drive 430 for reading from or writing to removable optical disk 431 such as a CD-ROM, DVD-ROM or other optical media. The magnetic hard disk drive 427, magnetic disk drive 428, and optical disk drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disk 431, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 439, magnetic disk 429, optical disk 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 is connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area network 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing system that includes a processor configured to process multimedia content and that is connected with one or more multimedia rendering devices that are configured to render the multimedia content, a method for enabling a user to navigate through multimedia content with a transcription file that includes one or more tokens corresponding to one or more elements of the multimedia content, the method comprising:
an act of receiving multimedia content, the multimedia content including multimedia elements;
a step for obtaining a transcription file that reflects an intended presentation of the multimedia content, the transcription file including one or more tokens that can be used to navigate through the multimedia content, each token including a link corresponding to one or more multimedia elements and a timestamp that corresponds to the one or more multimedia elements; and
an act of displaying the transcription file, such that one or more of the tokens can be selected to initiate rendering of the multimedia content, the rendering of the multimedia content commencing with rendering of the one or more multimedia elements that correspond to a selected token.

2. A method as recited in claim 1, wherein the multimedia content includes broadcast multimedia content.

3. A method as recited in claim 1, wherein at least one of the one or more tokens includes an image.

4. A method as recited in claim 1, wherein at least one of the one or more tokens includes one or more word.

5. A method as recited in claim 4, wherein the one or more word is derived from closed caption text.

6. A method as recited in claim 4, wherein the one or more word is derived from voice recognition performed on the multimedia content.

7. A method as recited in claim 1, wherein the step for obtaining a transcription file includes:
an act of identifying elements of the multimedia content that can be used to create the one or more tokens; and
an act of linking the one or more tokens to the corresponding one or more multimedia elements by timestamp, the transcription file reflecting an intended presentation of the multimedia content.

8. A method as recited in claim 1, wherein the step for obtaining a transcription file further includes an act of determining a hierarchal organization of the tokens, such that at least one token includes one or more sub-tokens, the one or more sub-tokens identifying and linking to one or more multimedia element of the multimedia content.

9. A method as recited in claim 1, wherein the act of displaying the transcription file includes simultaneously displaying the transcription file while the multimedia content is rendered.

10. A method as recited in claim 9, wherein the act of displaying the transcription file further includes displaying an indicator in the transcription corresponding to the current playback position of the multimedia content.

11. A method as recited in claim 1, wherein the computing system obtains the transcription file from a third party that is remote from the computing system.

12. A method as recited in claim 11, wherein the third party edits the transcription file.

13. In a computing system that includes a processor configured to process multimedia content and that is connected with one or more multimedia rendering devices that are configured to render the multimedia content, a method for enabling a user to navigate through the multimedia content with a transcription file that includes one or more tokens corresponding to one or more elements of the multimedia content, the method comprising:
an act of receiving multimedia content, the multimedia content including multimedia elements;
an act of creating a transcription file that reflects an intended presentation of the multimedia content, the transcription file linking each token to the one or more multimedia elements it identifies, such that the one or more tokens can be used to navigate through the multimedia content; and
an act of displaying the transcription file, such that one or more of the tokens can be selected to initiate rendering of the multimedia content, the rendering of the multimedia content commencing with rendering of one or more multimedia elements that correspond to a selected one of the one or more tokens.

14. A method as recited in claim 13, further including an act of displaying a current playback position of the multimedia content in the transcription file when the multimedia content is rendered.

15. A method as recited in claim 13, further including an act of determining a hierarchal organization of tokens, each token identifying one or more multimedia elements by timestamp, such that at least one token includes one or more sub-tokens, the one or more sub-tokens identifying and linking to one or more multimedia element of the multimedia content.

16. A method as recited in claim 15, wherein the hierarchal organization of tokens enables a user to determine which of the one or more tokens and sub-tokens is available for selection from the transcription file to initiate rendering of the multimedia content.

17. A method as recited in claim 13, wherein the multimedia content includes broadcast multimedia content.

18. A method as recited in claim 13, wherein at least one of the one or more tokens includes an image.

19. A method as recited in claim 18, wherein the image includes an image derived from image processing performed on the multimedia content.

20. A method as recited in claim 13, wherein at least one of the one or more tokens includes one or more word.

21. A method as recited in claim 20, wherein the one or more words is derived from closed caption or subtitle text corresponding to the multimedia content.

22. A method as recited in claim 20, wherein the one or more words is derived from voice recognition performed on the multimedia content.

23. A method as recited in claim 13 wherein the one or more of the tokens is derived from a stream transmitted with in the multimedia content

24. A method as recited in claim 23, wherein the tokens includes at least one of a time, a weather alert, a financial report, a sporting report, and a news report.

25. A method as recited in claim 13, wherein the one or more tokens is derived from a content recognition systems.

26. A method as recited in claim 13, wherein the one or more tokens includes an animation.

27. A method as recited in claim 13, wherein the act of displaying the transcription file, includes displaying the transcription file with an interface that enables editing of the transcription file.

28. A method as recited in claim 27, where a playback position of the multimedia content is indicated in the transcription file

29. A method as recited in claim 27, wherein editing of the transcription file includes one or more of moving, copying, amending and deleting a portion of the transcription file.

30. A method, as recited in claim 29, wherein the multimedia content is displayed in an order reflected by the edited transcription file.

31. A method as recited in claim 29, wherein editing of the transcription file includes editing one or more token.

32. A method as recited in claim 31, wherein the transcription file is edited by a third party that is remotely located from the computing system.

33. A computer program product for use in a computing system that includes a processor configured to process multimedia content and that is connected with one or more multimedia rendering devices that are configured to render the multimedia content, the computer program product comprising:
one or more computer-readable media having computer-executable instructions stored thereon for implementing a method for enabling a user to navigate through the multimedia content with a transcription file that includes one or more tokens corresponding to one or more elements of the multimedia content, the method including:
an act of receiving multimedia content, the multimedia content including multimedia elements;
an act of creating a transcription file that reflects an intended presentation of the multimedia content, the transcription file linking each token to the one or more multimedia elements it identifies, such that the one or more tokens can be used to navigate through the multimedia content; and
an act of displaying the transcription file, such that one or more of the tokens can be selected to initiate rendering of the multimedia content, the rendering of the multimedia content commencing with rendering of one or more multimedia elements that correspond to a selected one of the one or more tokens.

34. A computer program product as recited in claim 33, wherein the act of displaying the transcription file, includes displaying the transcription file with an interface that enables editing of the transcription file.

35. A computer program product as recited in claim 34, wherein editing of the transcription file includes one or more of moving, copying, amending and deleting a portion of the transcription file.

36. A computer program product as recited in claim 35, wherein the multimedia content is rendered in an order that is reflected by the edited transcription file.

37. A computer program product as recited in claim 33, wherein the method further includes an act of determining a hierarchal organization of tokens, each token identifying one or more multimedia elements by timestamp, such that at least one token includes one or more sub-tokens, the one or more sub-tokens identifying and linking to one or more multimedia element of the multimedia content.

38. A method as recited in claim 33, wherein the multimedia content includes broadcast multimedia content.

39. A method as recited in claim 33, wherein at least one of the one or more tokens includes an image.

40. A method as recited in claim 33, wherein at least one of the one or more tokens includes one or more word.

41. A method as recited in claim 40, wherein the one or more word is derived from closed caption text corresponding to the multimedia content.

42. A method as recited in claim 40, wherein the one or more word is derived from voice recognition performed on the multimedia content.

43. In a computing system that includes a processor configured to process multimedia content and that is connected with one or more multimedia rendering devices that are configured to render the multimedia content, a method for enabling a user to navigate through the multimedia content with a customizable transcription file that includes one or more tokens corresponding to one or more elements of the multimedia content, the method comprising:
an act of receiving multimedia content, the multimedia content including multimedia elements that are assigned corresponding timestamps;
an act of creating a customizable transcription file of tokens that reflect an intended presentation of the multimedia content, each token linking and identifying one or more multimedia elements by timestamp, such that the one or more tokens can be used to navigate through the multimedia content; and
an act of displaying the customizable transcription file in such a manner as to enable editing, such that a user can edit the customizable transcription file to alter the intended presentation of the multimedia content.

44. A method as recited in claim 43, wherein the act of displaying the transcription file enables the one or more tokens to be selected by a user to initiate rendering of the one or more multimedia segments identified by the selected one or more tokens.

45. A method as recited in claim 43, further including an act of receiving user input editing the transcription file.

46. A method as recited in claim 43, wherein the editing of the transcription file includes one or more of moving, copying, amending and deleting a portion of the transcription file.

47. A method as recited in claim 46, wherein the multimedia file is rendered in a sequence controlled by the transcription file as edited.

48. A method as recited in claim 46, wherein said portion of the transcription file includes a token.

49. A method as recited in claim 43, wherein editing the transcription file includes adding new matter to the transcription.

50. In a computing system that includes a processor configured to process multimedia content and that is connected with one or more multimedia rendering devices that are configured to render the multimedia content, a method for enabling a user to navigate through the multimedia content with a transcription file that includes one or more tokens corresponding to one or more elements of the multimedia content, the method comprising:
an act of receiving multimedia content, the multimedia content including multimedia elements;
an act of determining a hierarchal organization of tokens, each token identifying one or more multimedia elements by timestamp;
an act of preprocessing the tokens to obtain a desired display format of the tokens;
an act of creating a transcription file that reflects an intended presentation of the multimedia content, the transcription file linking each token to the one or more multimedia elements it identifies, such that the one or more tokens can be used to navigate through the multimedia content; and
an act of displaying the transcription file, such that one or more of the tokens can be selected to initiate rendering of the multimedia content, the rendering of the multimedia content commencing with rendering of one or more multimedia elements that correspond to a selected one of the one or more tokens,
the transcription file further being displayed in such a manner as to enable editing, such that a user can edit the transcription file to alter the intended presentation of the multimedia content.

51. A method as recited in claim 50, wherein the multimedia content includes broadcast multimedia content.

52. A method as recited in claim 50, wherein at least one of the one or more tokens includes an image.

53. A method as recited in claim 50, wherein at least one of the one or more tokens includes one or more word.

54. A method as recited in claim 53, wherein the one or more word is derived from closed caption text corresponding to the multimedia content.

55. A method as recited in claim 54, wherein the one or more word is derived from voice recognition performed on the multimedia content.

56. A method as recited in claim 55, further including an act of receiving user input selecting a token from the displayed transcription file to initiate rendering of the multimedia content.

57. A method as recited in claim 56, further including an act of receiving user input editing the transcription file prior to the act of receiving user input selecting the token to initiate rendering of the multimedia content.
